(19) United States
(12) Patent Application Publication
(10) Pub. No.: US 2003/0190439 A1
(43) Pub. Date: Oct. 9, 2003

(54) Transparent armor structure

(75) Inventor: Rene?apos; G. Gonzalez, Southfield, MI (US)

Correspondence Address: U.S. ARMY TACOM, ATTN: AMSTA-LP, 6501 E. 11 MILE ROAD, WARREN, MI, 48397-5000, US

(73) Assignee: The United States of America as represented by the Secretary of the Army, Washington, DC (US)

(21) Appl. No.: 10/117,556

(22) Filed: Apr. 3, 2002

(51) Int. Cl. E06B 3/24

(52) U.S. Cl. 428/34

(57) ABSTRACT

An improved transparent armor structure for use in a vehicle includes a first sheet of transparent armor composite comprising at least one layer of polycarbonate material and at least one layer of tempered silica glass bonded to form a laminated bullet resisting structure and also having a bracket member adapted to hold a second transparent spall resisting layer parallel to and slightly spaced from the inner surface of the first transparent composite layer. A spacing means between the first and second layers forms a chamber between the first and second panels and a desiccant is located within the chamber to minimize the amount of condensation on the surface of the transparent armor surfaces.

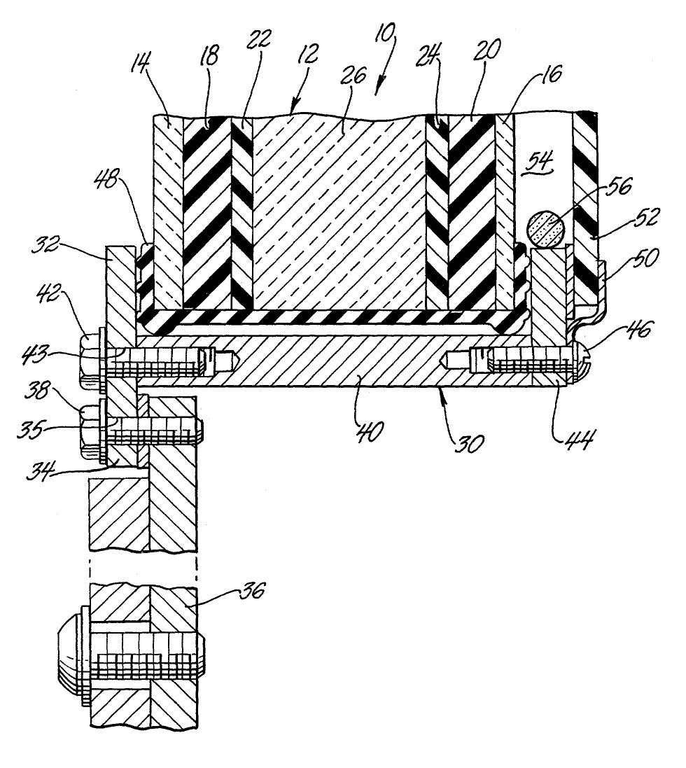

### GOVERNMENT INTEREST

The invention described here may be made, used and licensed by and for governmental purposes without paying me any royalty.

### BACKGROUND OF THE INVENTION

1. Field of the Invention

In one aspect this invention relates to armored vehicles. In a further aspect this invention relates to a transparent armor structure useful in military and security vehicles.

2. Prior Art

In general military vehicles require greater than average protection for the occupants. This has given rise to transparent armor structures for windshields and side windows that are designed to resist the incursion of small arms projectiles and shrapnel. This work has been ongoing for many years. In constructing transparent armor, “bullet proof” glass, sandwiches made from tempered glass, and plastic layers are bonded together to form complex sandwiches. The resulting sandwich must be transparent and optically free of distortion while maximizing ballistic protection from penetrators. In use the resulting sandwich will be subjected to shock, scratching abrasion and adverse weather conditions particularly when the armor is used in military applications.

The various layers used in the composite have different defined characteristics and functions. For example, tempered glass provides strength and penetration resistance as well as being highly abrasion resistant. However, glass is brittle which causes any glass layers opposite a penetration threat to spall, which in turn creates shrapnel fragments. The shrapnel comprises numerous projectiles and can be more dangerous than the original penetrator. On the other hand, plastic materials used as part of a composite sandwich provide a means to introduce flex properties into the transparent armor. This change is the failure mode of the transparent armor so it approaches a plug failure rather than a spall type fracture. Acrylic, polyurethane and polycarbonate based materials have all been shown to have utility in transparent armor structures.

Transparent sheet composites useful as transparent armor are known. One composite structure is shown in U.S. Pat. No. 5,506,051. This particular patent discloses a laminated glass and polycarbonate construction with the addition of one or more transition layers of cured aliphatic urethane. The urethane provides a tension absorbing transmission layer within the composite. This patent also describes glasses and plastic materials useful in forming laminates that can be used as transparent armor.

One plastic class that has proven reliable in the construction of transparent armor and bandit type barriers, is polycarbonate. This material has shown itself to be superior in terms of overall protection as the plastic with the highest spread between brittleness transition temperature and heat distortion temperature. Unfortunately, polycarbonate and the other useful plastic materials useful in the practice of this invention are soft and easily abraded. Thus when they are used as the final layer on the inside of a transparent armor construction, the optical properties are adversely effected by exposure to the ambient conditions and the abrasion resulting from cleaning. These conditions cause the transparency of the composite to degrade in as little as one year. The degradation requires replacement of the composite. Since the laminated structures are inherently expensive, frequent replacement creates a substantial financial burden on maintenance budgets. It appeared the only choices were to have a glass innermost layer associated with increased spalling risk or a plastic inner layer with the associated higher replacement cost. The armor assembly of the present invention provides a system with a basic structure, which can withstand the abrasion of the ambient environment and permit cleansing while providing a spall retaining inner layer.

### SUMMARY OF THE INVENTION

Briefly the present invention is an improved transparent armor structure for use in a vehicle. The armor includes a frame mounted to a vehicle, the frame adapted to firmly hold a first sheet of transparent ballistic armor composite. The composite will have an outer layer of glass material to provide both ballistic strength and abrasion resistance. The composite has in addition to the glass layer, at least one layer of plastic material, such as a polycarbonate material, integrally bonded to the outer layer of glass. The composite has an innermost layer of tempered silica glass integrally bonded to the plastic layer to form an abrasion resistant layer that can stand the abrasion and chemically active substances in the vehicle interior. The innermost layer can be cleaned using abrasive or solvent cleaners without degrading the composites optical properties. The composites useful in practicing this invention thus comprise at least three layers integrally bonded to form a laminated bullet resisting structure with the bonding adhesives and materials being such that the composite is optically clear and non-yellowing. Of course, the composite can be more than three lamellas thick. Various lamella are chosen from among assorted transparent materials chosen for their unique projectile resistance and flexibility characteristics.

The structure of this invention has a frame that encloses the composite structure that is in turn attached to the vehicle frame. The vehicle frame supports the entire transparent armor structure and associated members in place. A bracket, adapted to hold a freestanding transparent spall resisting layer parallel to and slightly spaced from the innermost surface of the laminated structure, is positioned on the inside of the vehicle. The bracket is formed and attached to the frame so the spall layer can be easily removed and replaced. The spall layer is formed from a transparent flexible material chosen from the type of materials used for the flexible ballistic layers in the laminate. While the spall layer can be scratched, or adversely effected by cleaning with solvents and abrasive cloths that attack its surface, it can be easily and inexpensively replaced while providing a good spall protection.

A spacing means is located between the composite and the separate spall layer along their edges to form a chamber between them. The chamber has a desiccant within the desiccant serving to minimize or eliminate the amount of moisture within the chamber so as to control any condensation, which creates transparency problems.

### BRIEF DESCRIPTION OF THE DRAWING

In the accompanying drawing:

The FIGURE is a partial side view in section of one embodiment of this invention.

### DETAILED DESCRIPTION

Referring to the accompanying drawing, an improved transparent armor structure according to this invention is designated generally as 10. A transparent armor composite 12 is shown with a plurality of lamella. Tempered glass lamella 14, 16 form the innermost and outermost layers of the composite. The glass lamella 14, 16 each have a layer of plastic material 18, 20 attached to their inner surface. As is common in such composites there are additional inner layers of material 22, 24. These layers will generally be additional layers of tempered glass, energy absorbing layers of plastic material or other types of strengthening material designed to provide the composite with additional penetration. The particular materials will be chosen based on the particular threat consideration. As shown, there is a final central layer 26, which again will be, chosen to maximize projectile resistance for the particular application. The materials useable are generally known in the transparent armor art and the choice will be dictated by the threat protection needed, weight allowance, optical properties and cost considerations. The innermost and outer most layers used in the present composite are tempered glass since that is without material which provides the greatest resistance to scratching and thus is the most desirable material on the outermost surfaces of the composite to preserve and maintain optical integrity. The choice of particular materials for each lamella is within the skill of the art and further description is omitted in the interest of brevity.

The laminated transparent armor 12 is mounted in a multi-part C-shaped frame 30 attached to a vehicle, not shown. The multiplied-part frame 30 surrounds and encloses the composite's 12 edge. The C-shaped multi-part frame 30 is formed to securely mount transparent armor composite 12 in a position normally associated with a vehicle window. In the multi-part frame 30 as shown, a first leg 32 provides one side of the C-shape of the frame and extends vertically beyond the frame boundary so as to provide a flange 34. The flange 34 has a first plurality of apertures 35 that allow the flange to be attached to a portion of the vehicle's frame 36 surrounding the opening to be protected. The flange 34 is secured to the vehicle frame 36 using a first plurality of threaded fasteners 38 passing through the first plurality of apertures 35. Threaded fasteners 38 are disposed at intervals around the periphery of the vehicle opening to provide proper support. The first vertical leg 32 of frame 30 is attached to a horizontal member 40 extending orthogonally into the vehicle's interior. The first vertical leg 32 is secured to the horizontal member 40 by a second plurality of threaded fasteners 42 passing apertures 43 through the first vertical leg 32 and engaging a mating aperture in the horizontal portion. At the opposite of the horizontal member 40, distal the first vertical leg 32 is a second vertical leg 44. The second vertical leg 44 is held in place by a third plurality of threaded fasteners 46 passing through the second vertical leg 44 and engaging threaded apertures in the horizontal portion. The resulting C-shaped frame structure 30 surrounds and holds the composite 12 in position to cover the opening and protect the vehicle's interior.

As noted before, glass while having good strength and abrasion resistance is brittle and subject to fracture and spalling. This is especially true when the edges are exposed to chipping and stressing even absent projectile incursion. Thus, to protect the edges and provide a seal for the edges of the composite 12, a shaped polymeric gasket 48 is disposed between the composite and the C-shaped frame 30 surrounding the composite's edge. The gasket 48 can be formed of various natural or synthetic polymeric sealing materials that will serve to seal the composite 12 and protect the composite within the C-shaped frame 30.

Because the composite 12 of this invention has glass layers as the innermost and outermost lamella to provide abrasion resistance, in the event of a projectile incursion, the inner layer 16 can spall to create fragments that must be retained. Thus, the structure of this invention adds a y-shaped bracket designated generally 50, adapted to hold a transparent spall resisting pane 52 parallel to and slightly spaced from the inner lamella 16 of the composite 12, the spall resisting pane being positioned on the inside face of the composite when mounted on the vehicle. The y-shaped bracket 50 is attached to the C-shaped bracket 30 using the third set of threaded fasteners 46 to allow easy removal of the spall pane 52 to clean the composite 12. When it is necessary to replace the spall-resisting pane 52 due to scratching or discoloration a new pane can being inserted at cleaning. The spall pane 52 will generally be formed from the same types of plastic materials as the flexible ballistic layers in the composite 12 such as polycarbonate or acrylic. Thus while the spall pane is subject to scratching, and can be adversely effected by cleaning with solvents and abrasive cloths, once the spall pane 52 has deteriorated a new one is easily installed. The expense is minimal as compared to replacing the entire composite 12 that is many times more expensive just in material costs.

The second vertical leg 44 of C-shaped bracket 30 acts as a spacer between the composite 12 and the spall pane 52 forming a chamber 54. The chamber 54 has a desiccant 56 disposed within the chamber, the desiccant serving to minimize or eliminate the moisture within the chamber to control the condensation. Condensation on surfaces will cause transparency problems and results in safety problems.

Various alterations and modifications will become apparent to those skilled in the art without departing from the scope and spirit of this invention and it is understood this invention is limited only by the following claims.

What is claimed is:

1. An improved transparent armor structure for use in a vehicle the armor including: a frame mounted to a vehicle, said frame being adapted to firmly hold a first sheet of transparent armor composite comprising at least one layer of polycarbonate material and at least one layer of tempered silica glass bonded to form a laminated bullet resisting structure; a bracket member adapted to hold a second transparent spall resisting layer parallel to and slightly spaced from the inner surface of the first transparent composite layer; spacing means located between the first and second layers, the spacing means being disposed along the edge of the panels to from a chamber between the first and second panels; desiccant located within the chamber the desiccant serving to minimize the amount of condensation on the surface of the transparent armor surfaces forming the chamber.
